(19) United States
(12) Patent Application Publication
(10) Pub. No.: US 2025/0197187 A1
(43) Pub. Date: Jun. 19, 2025

(54) BEVERAGE COMPONENT DISPENSING SYSTEM WITH A DOSING COLLAR

(71) Applicant: Starbucks Corporation, Seattle, WA (US)

(72) Inventors: Nathan C. Oren, Edgewood, WA (US); Joseph E. Gormley, Mercer Island, WA (US)

(21) Appl. No.: 18/978,631

(22) Filed: Dec. 12, 2024

Related U.S. Application Data
(60) Provisional application No. 63/609,785, filed on Dec. 13, 2023.

(51) Int. Cl. B67D 1/12; B67D 1/10

(52) U.S. Cl. CPC B67D 1/1231; B67D 1/102

(57) ABSTRACT

A dispensing system for dispensing a beverage component from a container may include a dosing collar configured to restrict flow of the beverage component through the tube. The dosing collar may be adjustable to modify a volume of the beverage component dispensed from a pump head when the pump head is actuated.

### INCORPORATION BY REFERENCE TO ANY PRIORITY APPLICATIONS

This application claims priority to U.S. Provisional Patent Application No. 63/609,785, filed Dec. 13, 2023, the entirety of which is incorporated herein by reference.

### FIELD

The present disclosure relates to a beverage component dispensing system, such as, in certain embodiments, beverage component dispensing system with an adjustable or modifiable dose size.

### BACKGROUND

Customized beverages can be created by adding different quantities of sauces, syrups, and flavors to a base beverage, such as coffee or tea. Sauces, syrups and flavors are currently dispensed using disposable mechanical pumps or reusable mechanical pumps. The sauce, syrup or flavor is filled in the pump container. A barista pumps the sauce, syrup or flavor by manually pushing down on the pump levers to dispense fixed volumes of sauces, syrups and flavors thru the pump nozzles.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

In some embodiments, a dispensing system for dispensing a beverage component may include a container configured to hold the beverage component and a pump coupled to the container. The pump may include a pump head configured to dispense a volume of the beverage component when the pump head is displaced from an uncompressed position to a compressed position. The dispensing system may include a dosing collar positioned between the pump head and the container. The pump head may contact the dosing collar when the pump head is in the compressed position. The dosing collar may be adjustable to modify a distance between the uncompressed position and the compressed position to modify the volume of the beverage component dispensed from the pump head when the pump head is actuated.

In some embodiments, the dispensing system may include an actuation system configured to displace the pump head from the uncompressed position to the compressed position and/or adjust the dosing collar.

In some embodiments, the dosing collar may include a plurality of restrictors. The dosing collar may be positioned so a restrictor of the plurality of restrictors is positioned between the pump head and the container.

In some embodiments, each restrictor of the plurality of restrictor may include a different height.

In some embodiments, the dosing collar may be configured to translate to change which restrictor of the plurality of restrictors is positioned between the pump head and the container.

In some embodiments, the dosing collar may be configured to rotate to change which restrictor of the plurality of restrictors is positioned between the pump head and the container.

In some embodiments, the distance between the uncompressed position and the compressed position may be based on a height of the restrictor positioned between the pump head and the container.

In some embodiments, a dispensing system for dispensing a beverage component may include a container configured to hold the beverage component and a pump coupled to the container. The pump may include a tube and a pump head. The dispensing system may include a dosing collar configured to restrict flow of the beverage component through the tube. The dosing collar may be adjustable to modify a volume of the beverage component dispensed from the pump head when the pump head is actuated.

In some embodiments, the dispensing system may include an actuation system configured to actuate the pump head and/or adjust the dosing collar.

In some embodiments, the tube may be bisected into a first portion and a second portion, and the dosing collar may be positioned between the first portion and the second portion.

In some embodiments, the dosing collar may include a plurality of openings extending through the dosing collar.

In some embodiments, each opening of the plurality of openings may include a different cross-sectional area.

In some embodiments, the dosing collar may be positioned between the first portion and the second portion so an opening of the plurality of openings may be aligned with the first portion and the second portion.

In some embodiments, a dispensing system may include a locking mechanism configured to prevent or inhibit movement of the dosing collar relative to the tube when an opening of the plurality of openings is aligned with the first portion and the second portion.

In some embodiments, each opening of the plurality of openings may be configured to form a seal with the first portion and the second portion. The seal may prevent or inhibit the beverage component from leaking out between the dosing collar and the first and second portions.

In some embodiments, the dosing collar may be configured to translate to change which opening of the plurality of openings is aligned with the first portion and the second portion.

In some embodiments, the dosing collar may be configured to rotate to change which opening of the plurality of openings is aligned with the first portion and the second portion.

In some embodiments, a dispensing system for dispensing a beverage component may include a container configured to hold the beverage component and a pump coupled to the container. The pump may include a tube and a pump head. The dispensing system may include a dosing collar that may include restrictors configured to move between a first position and a second position. The restrictors may not contact the tube when the restrictors are in the first position. The restrictors may be configured to restrict flow the beverage component through the tube when at least one of the restrictors are in the second position in order to modify a volume of the beverage component dispensed from the pump head when the pump head is actuated.

In some embodiments, the restrictors may each include a body and a recess extending into the body.

In some embodiments, the recess of each restrictor may be a different size.

In some embodiments, the recess of each restrictor may be a same size.

In some embodiments, the recess may be smaller than the tube so the body may neck down a portion of the tube when each restrictor is in the second position.

In some embodiments, a dosing collar for a beverage component dispensing system may include a body and a plurality of openings extending through the body. The dosing collar may be configured to restrict flow of the beverage component through a tube of the dispensing system. Each opening of the plurality of openings may be a different size, so each opening restricts flow of the beverage component through the tube of the dispensing system a different amount.

In some embodiments, the dosing collar may be configured to be positioned between a first portion of the tube and a second portion of the tube so a first opening of the plurality of openings may be aligned with the first portion and the second portion.

In some embodiments the dosing collar may be configured to translate relative to the tube so a second opening of the plurality of openings may be aligned with the first portion and the second portion.

In some embodiments, the dosing collar may be configured to rotate relative to the tube so a second opening of the plurality of openings may be aligned with the first portion and the second portion.

In some embodiments, the dosing collar may form a watertight seal with the tube.

### BRIEF DESCRIPTION OF THE DRAWINGS

Various embodiments are depicted in the accompanying drawings for illustrative purposes, and should in no way be interpreted as limiting the scope of the embodiments. Various features of different disclosed embodiments can be combined to form additional embodiments, which are part of this disclosure.

FIG. 1 illustrates an embodiment of a dispensing system with a dosing collar.

FIG. 2A illustrates a top perspective view of an embodiment of a dosing collar of the dispensing system of FIG. 1.

FIG. 2B illustrates a bottom perspective view of the dosing collar of FIG. 2A.

FIG. 3A illustrates a top view of an embodiment of the dispensing system of FIG. 1.

FIG. 3B illustrates a top view of an embodiment of the dispensing system of FIG. 1.

FIG. 4A illustrates a top view another embodiment of a dosing collar.

FIG. 4B illustrates a top view of another embodiment of a dispensing system with the dosing collar of 4A.

FIG. 5A illustrates a top view of another embodiment of a dosing collar.

FIG. 5B illustrates a top view of another embodiment of a dispensing system with the dosing collar of FIG. 5A.

FIG. 5C illustrates a side view of the dispensing system of FIG. 5B.

FIG. 6A illustrates another embodiment of a dispensing system with an embodiment of a dosing collar with a plurality of restrictors.

FIG. 6B illustrates the top view of a restrictor of the dosing collar of FIG. 6A.

FIG. 7 illustrates another embodiments of a dispensing system with an embodiment of a dosing collar with a plurality of restrictors.

FIG. 8 illustrates an embodiment of a locking mechanism of a dispensing system.

FIG. 9 illustrates another embodiment of a locking mechanism of a dispensing system.

FIG. 10 illustrates a control system of a dispensing system.

### DETAILED DESCRIPTION

Coffee or tea beverages usually have a base of coffee or tea extracts mixed with dairy enhanced by a variety of textures, tastes, flavors, colors and/or aromas. One can create different textures, tastes, flavors, colors and aromas by adding different quantities of ingredients or modifiers (e.g., sauces, syrups and flavors). For example, to create a menu offering of 70 handcrafted coffee beverages, there may be 10 flavors, 2 syrups and 7 sauces. Flavors are usually alcohol based. Examples of some flavors are vanilla, toffee nut, and hazelnut. Sauces are usually multiple ingredients blended together in a water solution. Examples of some sauces are white chocolate mocha, chai and mocha. Syrups are usually liquid forms of sugar or sugar-free substitutes.

Customized beverages can be created by adding different quantities of sauces, syrups, and flavors to a base beverage, such as coffee or tea. Sauces, syrups and flavors are typically dispensed from their respective containers using mechanical pumps. A barista may pump the ingredients or modifiers by manually pushing down on the pump levers to dispense the ingredients or modifiers through the pump nozzles.

Traditionally, syrup, sauce, and flavor pumps dispense a fixed volume per pump. However, beverages of different sizes and customizations often require a dose that varies from the fixed volume dispensed by the pump. For example, a beverage may include a half-pump dose of an ingredient, modifier, or enhancer (e.g., sauce, syrup, flavor, taste, color, reduction), where the fixed volume dispensed by the pump (e.g., a full-pump) may be 0.50 fl oz, and the half-pump may be 0.25 fl oz. The barista must manually actuate the pump to control the dose that is dispensed, so this process can be prone to human error, such as the barista dispensing an inaccurate amount of ingredient required for a specific drink. For example, the barista may actuate the pump to dispense a two thirds-pump dose of an ingredient, modifier, or enhancer when the beverage requires a half-pump. The process can also be time consuming, as the barista may be required to manually pump more than once to dispense the required amount.

Additionally, a coffee store may offer a menu with 80-100 hand-crafted beverages. Each beverage may be offered in different sizes. This means that each barista must memorize the recipes for each of the 80-100 beverages in different sizes, including the number of pumps, shots or doses for each of the ingredients or modifiers that are added. This creates a lot of complexity and memorization effort, which creates a challenge to maintain accuracy in beverage creation.

Customers like to adjust the amount of ingredients, modifiers, or enhancers (e.g., sauces, syrups, flavors, tastes, colors, reductions) in their beverages to suit their individual taste and health needs. For example, a customer may want half the sugar syrup and twice the amount of vanilla flavor of the normal recipe for a particular beverage. Baristas may want to simplify the mental efforts required in the beverage preparation process to increase throughput of beverage or a rate at which beverages, particularly complex beverages, may be made while maintaining accuracy.

In accordance with several embodiments, the dispensing systems described herein advantageously adjust a volume of an ingredient, modifier or enhancer (e.g., sauces, syrups, flavors, tastes, colors, reductions) in a dose dispensed from a dispenser. The volume of the dose may be modified with a dosing collar. The dosing collar may be adjusted so actuation of a pump may dispense a desired volume of the ingredient, modifier, or enhancer. The dispensing system may automatically adjust the dosing collar so actuation of the pump dispenses the desired volume of the ingredient, modifier, or enhancer. The dosing collar may ensure that the volume of the ingredient, modifier, or enhancer dispensed from the pump is accurate and/or consistent with the desired volume of the ingredient, modifier, or enhancer. For example, the dosing collar may ensure that a half-pump of the ingredient, modifier, or enhancer is dispensed when the desired volume is a half-pump instead of a full pump, where a half-pump may be 0.25 fl oz and a full-pump may be 0.50 fl oz. The dosing collar may reduce or minimize the human error when manually dispensing a volume of the ingredient, modifier, or enhancer that is less than a full pump (e.g., a fixed volume dispensed by the pump when the pump is fully actuated).

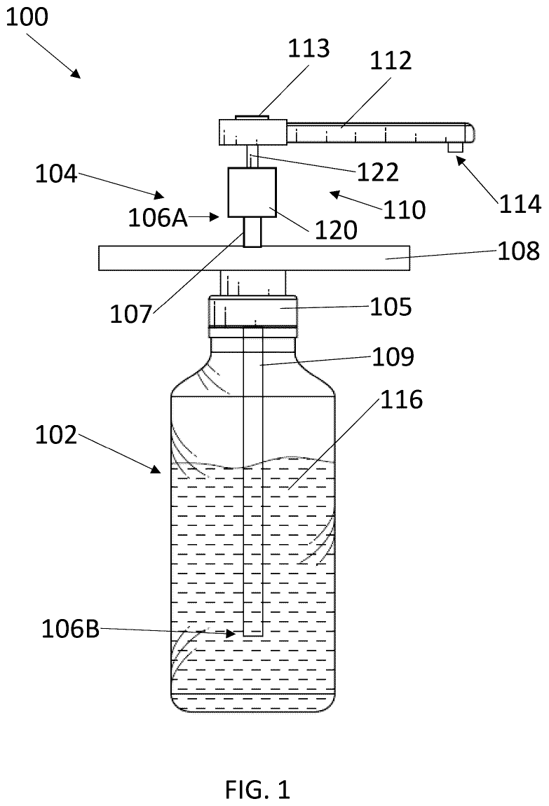

FIG. 1 illustrates a dispensing system 100 according to an embodiment of the present disclosure. The dispensing system 100 may include a container 102, a pump 104, and/or a dosing collar 108. The container 102 may be configured to hold a beverage component 116. The beverage component 116 may include an ingredient, modifier or enhancer (e.g., sauces, syrups, flavors, tastes, colors, reductions).

The pump 104 may be a mechanical pump that is manually actuated by a user. The pump 104 may be configured to dispense the beverage component 116 from the container 102 when the pump 104 is manually actuated. The pump 104 may include a cover 105, a tube 106, a pumping assembly 110, and/or a pump head 112. The tube 106 may extend from a first end 106A to a second end 106B.

The pump 104 may be coupled to the container 102 via the cover 105. The cover 105 may removably couple to the container 102 so the cover 105 is positioned over the opening 118. In some embodiments, the cover 105 may form an airtight or substantially airtight seal with the container 102. The cover 105 may be coupled to the tube 106 between the first end 106A and the second end 106B so the tube 106 extends through the cover 105. Accordingly, when the cover 105 is coupled to the container 102, the first end 106A of the tube 106 may be positioned outside of the container 102 and the second end 106B may be positioned inside the container 102.

The pumping assembly 110 may include a housing 120 and an actuator 122. The housing 120 may be coupled to the first end 106A of the tube 106. The actuator 122 may be coupled to the housing 120 so at least a portion of the actuator 122 extends into the housing 120. In some embodiments, the actuator 122 may be slidably coupled to the housing 120 so the actuator 122 may translate in a longitudinal direction relative to the housing 120.

The actuator 122 may translate between an uncompressed position and a compressed position. When the actuator 122 is displaced or translated from the uncompressed position to the compressed position, the actuator 122 may be displaced or translate into the housing 120 to dispense the beverage component 116. The pump head 112 may be coupled to the actuator 122. When the actuator 122 into the housing 120, the beverage component 116 may be drawn through the tube 106, the housing 120, and/or the actuator 122 and dispensed from the pump head 112 via an opening 114 in the pump head 112. The beverage component 116 may be drawn into the tube 106 at the second end 106B of the tube 106.

A force may be applied to the pump head 112 in order to actuate the pump head 112. When the pump head 112 is actuated, the actuator 122 may translate into the housing 120. In some embodiments, the force may be manually applied to the pump head 112 (i.e., by a user) so the actuator 122 is manually translated from the uncompressed position to the compressed position. In some embodiments, the force may be applied to the pump head 112 by a motor and/or an electronic controller so the actuator 122 may be automatically translated.

The pumping assembly 110 may include a spring (not shown). The spring may be positioned in the housing 120. The spring may be coupled to the actuator 122 and/or the housing 120. The spring may apply a force to the actuator 122 in order to displace or translate the actuator 122 out of the housing 120 to the uncompressed position after the actuator 122 is displaced or translated to the compressed position.

The dosing collar 108 may be externally attached to the pump 104. The tube 106 may be transversely bisected into a first portion 107 and a second portion 109. The dosing collar 108 may be coupled to the tube 106 so the dosing collar 108 is positioned between the first portion 107 and the second portion 109. The dosing collar 108 may couple the first portion 107 and the second portion 109. The first portion 107 may extend from the first end 106A of the tube 106 to dosing collar 108 and the second portion 109 may extend from the dosing collar 108 to the second end 106B of the tube 106.

The dosing collar 108 may be adjustable. The dosing collar 108 may be configured to translate relative to the tube 106 in order to modify a volume of the beverage component 116 dispensed from the pump 104 when the actuator 122 is manually moved to the compressed position. In some embodiments, the dosing collar 108 may be translated by a user. In some embodiments, the dosing collar 108 may be translated by an actuation system (not shown), for example, a cam, a linear actuator, a rotary actuator, and/or any other actuation system.

The dispensing system 100 may include a locking mechanism. The locking mechanism may be configured to prevent or inhibit the dosing collar 108 from translating (e.g., moving) relative to the tube 106 when an opening in the dosing collar 108 is aligned with the tube 106.

The pump head 112 may include an indicator 113. The indicator may include one or more LEDs, an LCD display, an OLED display and/or any other form of electronic light or display. The indicator 113 may be configured to indicate to a user that the beverage component 116 in the container 102 is part of a beverage order.

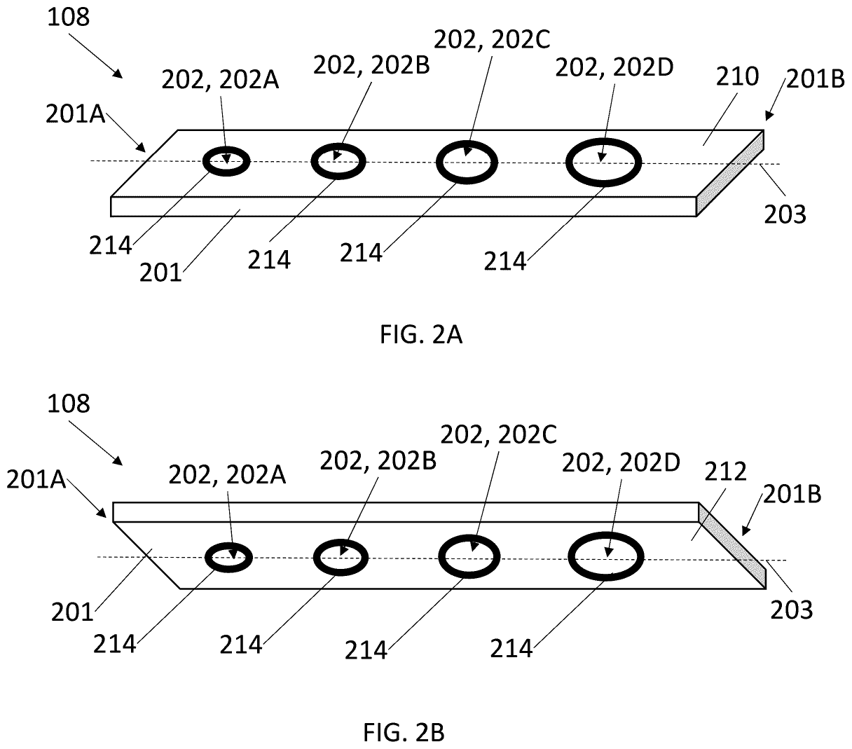

FIGS. 2A and 2B illustrate the dosing collar 108. The dosing collar 108 may include a body 201 and a plurality of openings 202 extending through the body 201 from a first surface 210 to a second surface 212. The body 201 may include a prism shape, for example a rectangular prism. The plurality of openings 202 may be positioned on the body 201 so the plurality of openings 202 are positioned along an axis 203 extending from a first end 201A of the body to a second end 201B of the body 201. The plurality of openings 202 may be equally spaced between the first end 201A and the second end 201B so a center point of each of the plurality of openings 202 are positioned a same distance from each other.

The dosing collar 108 may be coupled to the tube 106 so an opening 202 aligns with the tube 106 (e.g., the first portion 107 and the second portion 109). The dosing collar 108 may be translated relative to the tube 106 in order to change which opening 202 is aligned with the tube 106. The dosing collar 108 may be configured to translate in a direction along the axis 203. In some embodiments, the dosing collar 108 may be bisected along the axis 203 into a first portion 108A and a second portion 108B. Therefore, the first portion 108A and the second portion 108B may be decoupled (i.e., separated) from each other to allow the dosing collar 108 to be translated relative to the tube 106. After the dosing collar 108 is translated relative to the tube 106, the first portion 108A and the second portion 108B may be coupled together to secure the dosing collar 108 to the tube 106. The first portion 108A and the second portion 108B may be configured to rotate about the first end 201A or the second end 201B in order to decouple (i.e., separate) the first portion 108A and the second portion 108B.

A cross-sectional area of the openings 202 may be different from a cross-sectional area of the tube 106. Therefore, the openings 202 may restrict flow of the beverage component 116 through the tube 106 (i.e., from the second portion 109 to the first portion 107) to modify a volume of the beverage component 116 dispensed from the pump 104 when the actuator 122 is moved to the compressed position by modifying a cross-sectional area of a portion of a flow path through the 106 and the openings 202. The openings 202 may restrict flow of the beverage component 116 through the tube 106 without any internal valve components.

The dosing collar 108 may include a first opening 202A, a second opening 202B, a third opening 202C, and/or a fourth opening 202D. Each of the first opening 202A, the second opening 202B, the third opening 202C, and the fourth opening 202D may include a different cross-sectional area. Therefore, each opening 202A, 202B, 202C, 202D may restrict flow of the beverage component 116 through the tube 106 a different amount. For example, the first opening 202A may restrict flow of the beverage component 116 through the tube 106 more than the second opening 202B and a volume of beverage component 116 dispensed from the pump 104 when the first opening 202A is aligned with the tube 106 may be smaller than a volume of the beverage component 116 dispensed from the pump 104 when the second opening 202B is aligned with the tube 106.

A cross-sectional area of the first opening 202A may be smaller than a cross-sectional area of the second opening 202B, the cross-sectional area of the second opening 202B may be smaller than a cross-sectional area of the third opening 202C, and the cross-sectional area of the third opening 202C may be smaller than a cross-sectional area of the fourth opening 202D.

Each opening 202 may include seals 214. The seals 214 may be coupled to an edge of each opening 202 on the first surface 210 and the second surface 212. The seals 214 may form a watertight and/or airtight with the first portion 107 and/or the second portion 109. The seal 214 may prevent or inhibit beverage ingredient 116 from flowing (i.e., leaking) between the dosing collar 108 and the first portion 107 of the tube 106 and/or the dosing collar 108 and the second portion 109 of the tube 106. The seal 214 may include silicone, platinum cured silicone, neoprene, ethylene propylene diene terpolymer (EPDM), and/or any other material commonly used for airtight or watertight sealing.

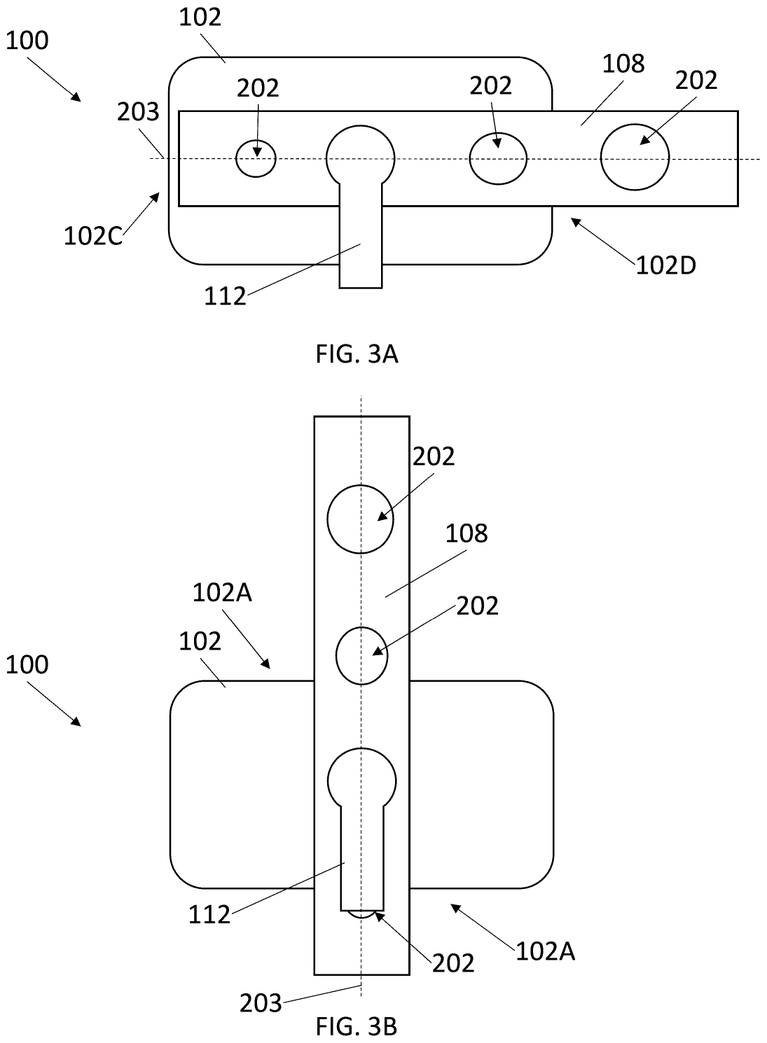

FIGS. 3A and 3B illustrate top views of the dispensing system 100. As shown in FIG. 3A, the dosing collar 108 may be positioned so the axis 203 extends in a direction from a first side 102C to a second side 102D of the container 102 so the axis 203 is perpendicular or substantially perpendicular to the pump head 112. The dosing collar 108 may be configured to translate towards the first side 102C and/or the second side 102D to change which opening 202 is aligned with the tube 106.

As shown in FIG. 3B, the dosing collar 108 may be positioned so the axis 203 extends in a direction from a front 102A of the container 102 to the back 102B of the container 102 so the dosing collar 108 is aligned with the pump head 112. The dosing collar 108 may be configured to translate towards the front side 102A and/or the back side 102B to change which opening 202 is aligned with the tube 106. Therefore, when a plurality of dispensing systems 100 are positioned adjacent to each other, the dispensing systems 100 may not prevent or inhibit translation of the dosing collar 108 of an adjacent dispensing system 100.

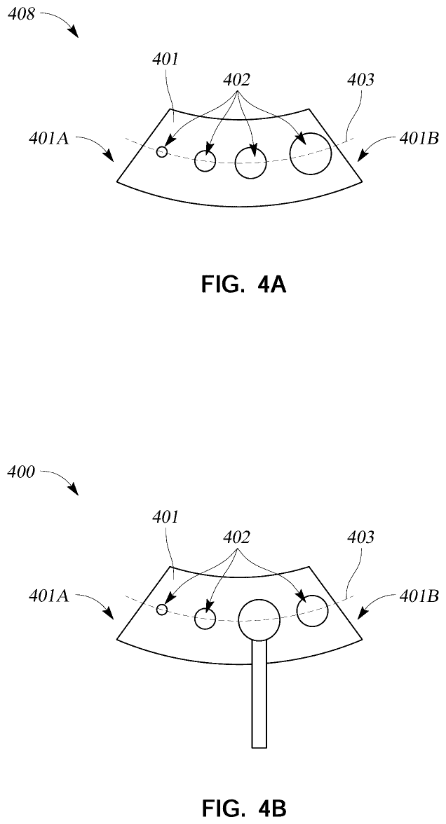

FIGS. 4A and 4B illustrate another embodiment a dosing collar 408 and a dispensing system 400 with the dosing collar 408. The dispensing system 400 can include any of the features of dispensing system 100, and the dispensing system 100 can include any of the features of dispensing system 400. The dosing collar 408 can include any of the features of dosing collar 108, and the dosing collar 108 can include any of the features of dosing collar 408. Common features between the dosing collar 408 and the dosing collar 108, and the dispensing system 400 and the dispensing system 100 will not be described again but are incorporated here in their entirety. As shown in FIG. 4A, a body 401 of the dosing collar 408 may include a curved configuration or an arc shape. The body 401 may be curved along an axis 403 extending from a first end 401A of the body 401 to a second end 401B of the body 401. As shown in FIGS. 4B, the dosing collar 408 may be rotated or twisted to change which opening 402 of the dosing collar 408 is aligned with a tube of the dispensing system 400. The openings 402 may restrict flow of a beverage component through a tube without any internal valve components.

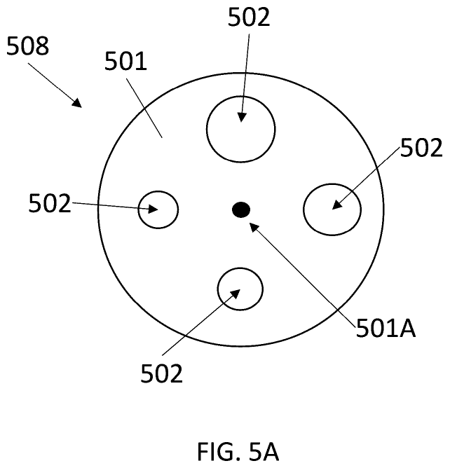

FIGS. 5A-5C illustrate another embodiment of a dosing collar 508 and a dispensing system 500 with the dosing collar 508. The dispensing system 500 can include any of the features of dispensing system 100, 400, and the dispensing system 100, 400 can include any of the features of dispensing system 500. The dosing collar 508 can include any of the features of dosing collar 108, 408, and the dosing collar 108, 408 can include any of the features of dosing collar 508. Common features between the dosing collar 508 and the dosing collar 108, 408 and the dispensing system 500 and the dispensing system 100, 400 will not be described again but are incorporated here in their entirety. As shown in FIG. 5A, a body 501 of the dosing collar 508 may include a disc shape. A plurality of openings 502 of the dosing collar 408 may positioned circumferentially around a center 501A of the body 501. In some embodiments, the plurality of openings 502 may be equally spaced around the center 501A of the body 501.

As shown in FIGS. 5B and 5C, the dosing collar 508 may be coupled to the tube 506 so the center 501A of the body 501 is offset from the tube 506. The center 501A may be positioned behind the tube 506 and/or the container 520. The dosing collar 508 may be rotated around the center 501A of the body 501 in order to change which opening 502 is aligned with the tube 506. The openings 502 may restrict flow of a beverage component through the tube 506 without any internal valve components.

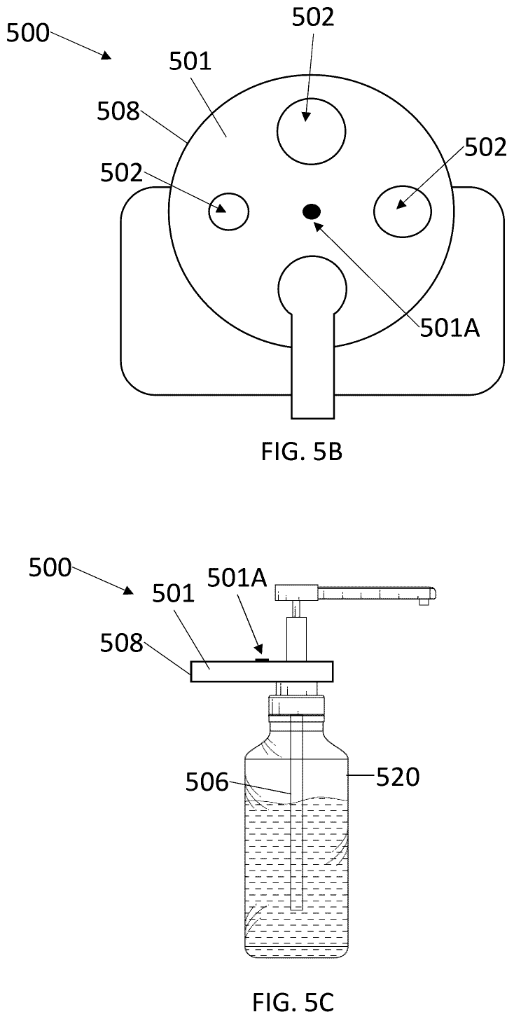

FIGS. 6A and 6B illustrate another embodiment of a dosing collar 608 and a dispensing system 600 with the dosing collar 608. The dispensing system 600 can include any of the features of dispensing system 100, 400, 500 and the dispensing system 100, 400, 500 can include any of the features of dispensing system 600. The dosing collar 608 can include any of the features of dosing collar 108, 408, 508, and the dosing collar 108, 408, 508 can include any of the features of dosing collar 608. Common features between the dosing collar 608 and the dosing collar 108, 408, 508 and the dispensing system 600 and the dispensing system 100, 400, 500 will not be described again but are incorporated here in their entirety. The dosing collar 608 may include a plurality of restrictors 610. The restrictors 610 may include a body 611 with a recess 612 extending into the body 611. The body 611 may include a horseshoe shape or arc shape. In some embodiments, each restrictor 610 may include a different sized recess 612. In some embodiments, each restrictor 610 may include a same sized recess 612. The restrictors 610 may be stacked so the recesses 612 of the restrictors 610 are aligned.

The restrictors 610 may be configured to translate between a first position 610A and a second position 610B. When the restrictors 610 are in the first position 610A the restrictors 610 may not contact a tube 606 of the dispensing system 600. When the restrictors 610 are in the second position 610B, the tube 606 may be positioned in the recess 612 of the restrictors 610. The recess 612 of the restrictors 610 may be smaller than the tube 606. Accordingly, when the restrictors 610 are in the second position 610B, the body 611 of the restrictors 610 may neck down (i.e., compress, pinch, etc.) the tube 606 to restrict flow of a beverage ingredient through the tube 606. The dosing collar 608 and the restrictors 610 are not exposed to any fluid and do not contact any fluids in the tube 606. The restrictors 610 may restrict flow of a beverage component through the tube 606 without any internal valve components.

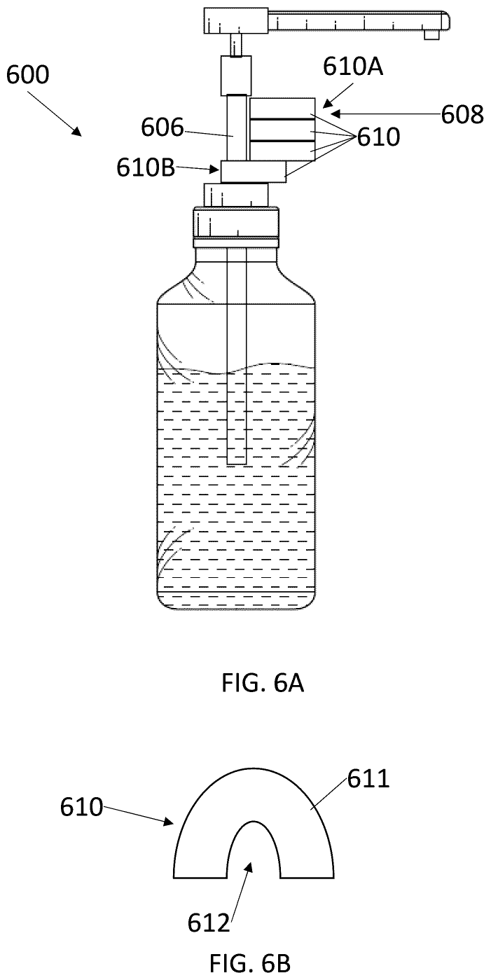

FIG. 7 illustrates another embodiment of dosing collar 708 and a dispensing system 700 with the dosing collar 708. The dispensing system 700 can include any of the features of dispensing system 100, 400, 500, 600 and the dispensing system 100, 400, 500, 600 can include any of the features of dispensing system 700. The dosing collar 708 can include any of the features of dosing collar 108, 408, 508, 608 and the dosing collar 108, 408, 508, 608 can include any of the features of dosing collar 708. Common features between the dosing collar 708 and the dosing collar 108, 408, 508, 608 and the dispensing system 700 and the dispensing system 100, 400, 500, 600 will not be described again but are incorporated here in their entirety. The dispensing system 700 may include a pump 704 and a container 702. The pump 704 may include a pump head 712 and a tube 706. The pump 704 may dispense a predetermined volume of beverage component from the container 702 when the pump head 712 is actuated. When the pump head 712 is actuated, the pump head 712 may be displaced between an uncompressed position, as shown in FIG. 7, and a compressed position. When the pump head 712 is in the uncompressed position the pump head 712 may be positioned a distance 713 from the container 102. The pump head 712 may be displaced the distance 713 to dispense the predetermined volume of beverage component.

The dosing collar 708 may include a plurality of restrictors 710. The restrictors 710 may each include a height 714. The height 714 may be a distance from a bottom 708A of the dosing collar 708 to a top surface 711 of each restrictor 710. The height 714 of the plurality of restrictors 710 may vary. Each restrictor 710 may include a different height 714. A first restrictor 710A may include a first height 714A, a second restrictor 710B may include a second height 714B, a third restrictor 710C may include a third height 714C, and/or a fourth restrictor 710D may include a fourth height 714D. The fourth height 714D may be longer than the third height 714C, the third height 714C may be longer than the second height 714B, and/or the second height 714B may be longer than the first height 714A.

One of the plurality of restrictors 710 may be positioned around and/or adjacent to the tube 706 between the pump head 712 and the container 702. The pump head 712 may be positioned a distance 718 from the top surface 711 of the restrictor 710 when the pump head 712 is in the uncompressed position. The pump head 712 may contact the restrictor 710 when the pump head 712 is in the compressed position. The restrictor 710 may prevent or inhibit the pump head 712 from being displaced the past the top surface 711 of the restrictor 710 when the pump head 712 is actuated. Accordingly, the restrictor 710 may prevent or inhibit the pump head 712 from being displaced the entire distance 713 and/or the pump head 712 may only be displaced the distance 718. Therefore, the pump 704 may only dispense a portion of the predetermined volume of beverage component. The volume of beverage component dispensed by the pump 704 may be based on the height 714 of the restrictor 710 positioned between the pump head 712 and the container 702.

The dosing collar 708 may be adjustable. The dosing collar 708 may be configured to translate relative to the tube 706 in order to change the restrictor 710 positioned around and/or adjacent to the tube 706 between the pump head 712 and the container 702 in order to modify the volume of the beverage component dispensed from the pump 704 when the pump head 712 is actuated. For example, the dosing collar 708 may be positioned so the first restrictor 710A is positioned between the pump head 712 and the container 702. When the first restrictor 710A is positioned between the pump head 712 and the container 702 the distance 718 may be the distance 713 minus the first height 714A and the pump 704 may dispense a first portion of the predetermined volume of beverage component. The dosing collar 708 may translate and/or rotate so the second restrictor 710B is positioned around and/or adjacent to the tube 706 between the pump head 712 and the container 702 instead of the first restrictor 710A. When the second restrictor 710B is positioned between the pump head 712 and the container 702 the distance 718 may be the distance 713 minus the second height 714B and the pump 704 may dispense a second portion of the predetermined volume of beverage component where the second portion is smaller than the first portion. The dosing collar 708 and the restrictors 710 are not exposed to any fluid and do not contact any fluids in the tube 706. The restrictors 710 may restrict flow of a beverage component through the tube 706 without any internal valve components.

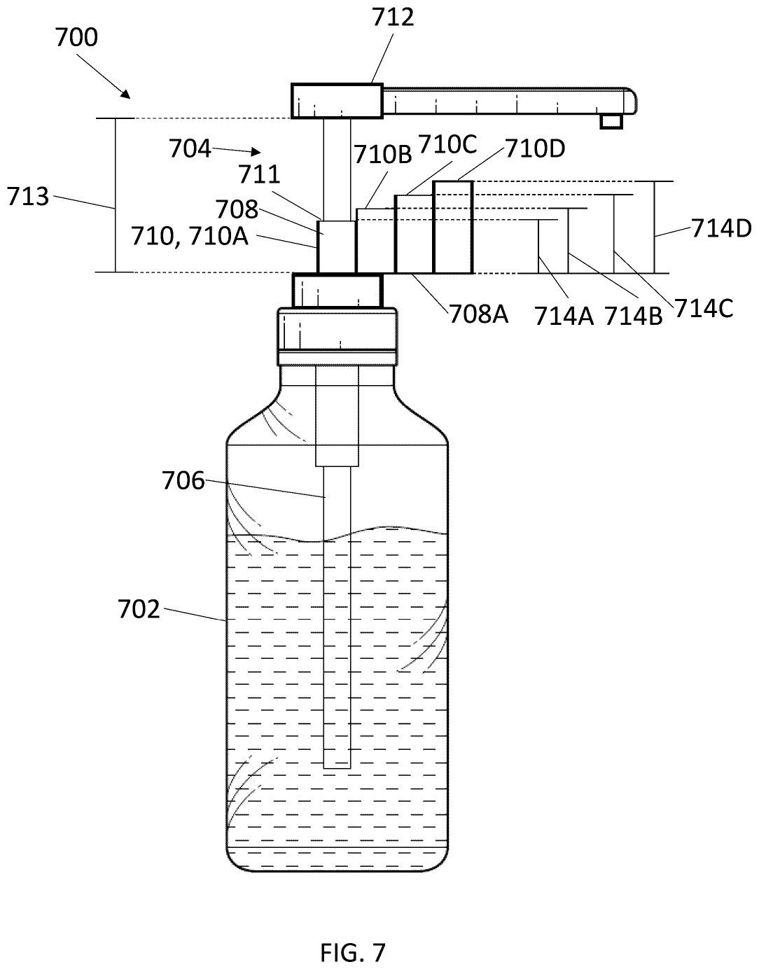

FIG. 8 illustrates an embodiment of a locking mechanism 810 for a dosing collar 808 of a dispensing system 800. The dispensing system 800 can include any of the features of dispensing system 100, 400, 500, 600, 700 and the dispensing system 100, 400, 500, 600, 700 can include any of the features of dispensing system 800. The dosing collar 808 can include any of the features of dosing collar 108, 408, 508, 608, 708 and the dosing collar 108, 408, 508, 608, 708 can include any of the features of dosing collar 808. Common features between the dosing collar 808 and the dosing collar 108, 408, 508, 608, 708 and the dispensing system 800 and the dispensing system 100, 400, 500, 600, 700 will not be described again but are incorporated here in their entirety. The locking mechanism may include a locking flag 820 and a locking ring 822. The locking ring 822 may be slidably coupled to the tube 806. The locking flag 820 may be coupled to the dosing collar 808. In some embodiments, the dosing collar 808 may include a locking flag 820 positioned at each opening in the dosing collar 808. When an opening is aligned with the tube 806, the locking flag 820 positioned at the opening may be aligned with the locking ring 822 and the locking ring 822 may be configured to engage with the locking flag 820 to prevent or inhibit the dosing collar 808 from translating relative to the tube 806.

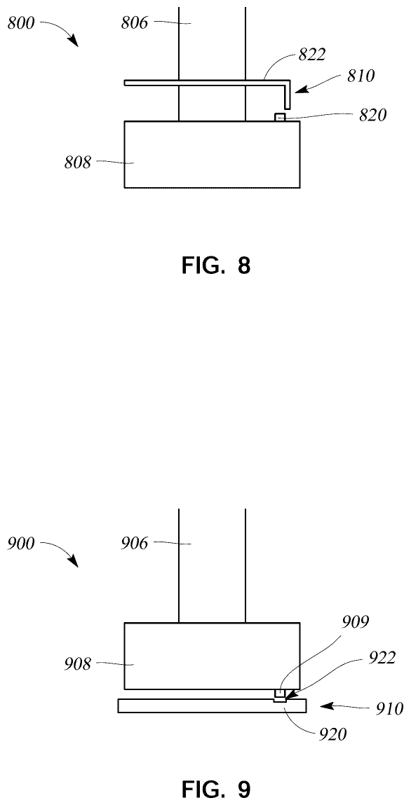

FIG. 9 illustrates another embodiment of a locking mechanism 910 for a dosing collar 908 of a dispensing system 900. The dispensing system 900 can include any of the features of dispensing system 100, 400, 500, 600, 700, 800 and the dispensing system 100, 400, 500, 600, 700, 800 can include any of the features of dispensing system 900. The dosing collar 908 can include any of the features of dosing collar 108, 408, 508, 608, 708, 808 and the dosing collar 108, 408, 508, 608, 708, 808 can include any of the features of dosing collar 908. Common features between the dosing collar 808 and the dosing collar 108, 408, 508, 608, 708, 808 and the dispensing system 900 and the dispensing system 100, 400, 500, 600, 700, 800 will not be described again but are incorporated here in their entirety. The locking mechanism 910 may include a plate 920 coupled to a container and/or a cover of the dispensing system 900. The plate 920 may include a recess 922. A dosing collar 908 of the dispensing system 900 may include an extension 909 that extends from a body 901 of the dosing collar 908. In some embodiments, the dosing collar 908 may include a plurality of extensions 909 at each opening of the dosing collar 908. When an opening in the dosing collar 908 is aligned with a tube 906 of the dispensing system 900, the extension 909 at the opening may extend into the recess 922. The extension 909 may engage with the recess 922 to prevent or inhibit translation of the dosing collar 908 relative to the tube 906.

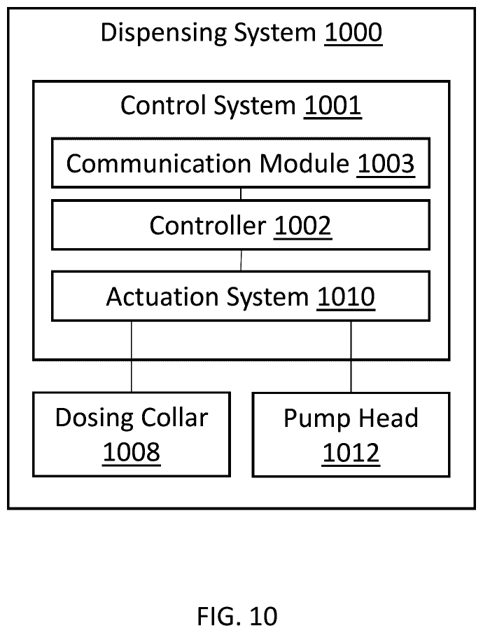

FIG. 10 illustrates a schematic of a dispensing system 1000 with a control system 1001. The dispensing system 1000 can include any of the features of dispensing system 100, 400, 500, 600, 700, 800, 900 and the dispensing system 100, 400, 500, 600, 700, 800, 900 can include any of the features of dispensing system 1000. Common features between the dispensing system 1000 and the dispensing system 100, 400, 500, 600, 700, 800, 900 will not be described again but are incorporated here in their entirety. The control system 1001 may include a controller 1002, a communication module 1003, and/or an actuation system 1010. The communication module 1003 may be configured to transmit and/or receive signals wirelessly or via a wired connection. The communication module 1003 may communicate with a point of sale system. The communication module 1003 may receive one or more beverage orders from the point of sale system.

The controller 1002 may transmit instructions to the actuation system 1010 to control the actuation system 1010. Based on the instructions received from the controller 1002, the actuation system 1010 may move (i.e., translate, slide, rotate, twist, etc.) a dosing collar 1008 of the dispensing system 1000. Based on the instructions received from the controller 1002, the actuation system 1010 may actuate a pump head 1012 of the dispensing system 1000. The controller 1002 may transmit instructions to the actuation system via a wired connected or a wireless connection (i.e., Wi-Fi, Bluetooth®, Bluetooth® Low Energy, a cellular connection, ultra-wideband (UWB), RFID, NFC, wireless local area network (WLAN), etc.). The actuation system 1010 may include a cam, a linear actuator, a rotary actuator, and/or any other actuator.

The communication module 1003 may include a scanner configured to scan or read one or more machine readable codes. The one or more machine readable codes may include a barcode, a QR code, and/or any other machine-readable optical label and/or other machine-readable codes. The one or more machine readable codes may contain information that includes one or more beverage orders.

The dosing collars 108, 408, 508, 608, 708, 808, 908 can be coupled to a dispenser with a manually actuated pump. The dosing collars 108, 408, 508, 608, 708, 808, 908. The dosing collars 108, 408, 508, 608, 708, 808, 908 can be externally attached to any dispenser with a manually actuated pump. The dosing collars 108, 408, 508, 608, 708, 808, 908 can be removed from a first dispenser with a manually actuated pump and attached to a second dispenser with a manually actuated pump so the dosing collars 108, 408, 508, 608, 708, 808, 908 can be used with the second dispenser when a container of the first dispenser is empty. The manually actuated pump and the dosing collar 108, 408, 508, 608, 708, 808, 908 may be removed from a first container and coupled to a second container so the dosing collar 108, 408, 508, 608, 708, 808, 908 and the manually actuated pump can be used to dispense a beverage ingredient in the second container when the first container is empty.

### Certain Terminology

As used herein, the term “beverage” has its ordinary and customary meaning, and includes, among other things, any edible liquid or substantially liquid substance or product having a flowing quality (e.g., juices, coffee beverages, teas, milk, beer, wine, cocktails, liqueurs, spirits, cider, soft drinks, flavored water, energy drinks, soups, broths, combinations of the same, or the like).

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. Numbers preceded by a term such as “about” or “approximately” include the recited numbers and should be interpreted based on the circumstances (e.g., as accurate as reasonably possible under the circumstances, for example. For example, “about 1 gram” includes “1 gram.” In the embodiments described in this application, terms such as “about” or “approximately” within the specification or claims that precede values or ranges can be omitted such that this application specifically includes embodiments of the recited values or ranges with the terms “about” or “approximately” omitted from such values and ranges such that they can also be claimed without the terms “about” or “approximately” before the disclosed range. The term “generally” as used herein represents a value, amount, or characteristic that predominantly includes, or tends toward, a particular value, amount, or characteristic. As an example, in certain embodiments, as the context may dictate, the term “generally parallel” can refer to something that departs from exactly parallel by less than or equal to 20 degrees and/or the term “generally perpendicular” can refer to something that departs from exactly perpendicular by less than or equal to 20 degrees.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

### SUMMARY

Although certain aspects, advantages, and features are described herein, it is not necessary that any particular embodiment include or achieve any or all of those aspects, advantages, and features. For example, some embodiments may not achieve the advantages described herein, but may achieve other advantages instead. Any structure, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable. In addition, although this disclosure describes certain embodiments and examples of beverage systems and methods, many aspects of the above-described systems and methods may be combined differently and/or modified to form still further embodiments or acceptable examples. All such modifications and variations are intended to be included herein within the scope of this disclosure.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Some embodiments have been described in connection with the accompanying drawings. The figures are drawn to scale, but such scale should not be interpreted to be limiting. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Also, any methods described herein may be practiced using any device suitable for performing the recited steps.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of beverage dispensing systems with a dosing collar, and methods of operating the beverage dispensing systems have been disclosed. Although the systems and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

1. (canceled)

2. (canceled)

3. (canceled)

4. (canceled)

5. (canceled)

6. (canceled)

7. (canceled)

8. A dispensing system for dispensing a beverage component, the dispensing system comprising:
a container configured to hold the beverage component;
a pump coupled to the container, the pump comprising a tube and a pump head;
a dosing collar configured to restrict flow of the beverage component through the tube,
wherein the dosing collar is adjustable to modify a volume of the beverage component dispensed from the pump head when the pump head is actuated.

9. The dispensing system of claim 8, further comprising an actuation system configured to actuate the pump head and/or adjust the dosing collar.

10. The dispensing system of claim 8, wherein the tube is bisected into a first portion and a second portion, and wherein the dosing collar is positioned between the first portion and the second portion.

11. The dispensing system of claim 10, wherein the dosing collar comprises a plurality of openings extending through the dosing collar.

12. The dispensing system of claim 11, wherein each opening of the plurality of openings comprises a different cross-sectional area.

13. The dispensing system of claim 11, wherein the dosing collar is positioned between the first portion and the second portion so an opening of the plurality of openings is aligned with the first portion and the second portion.

14. The dispensing system of claim 13, further comprising a locking mechanism configured to prevent or inhibit movement of the dosing collar relative to the tube when an opening of the plurality of openings is aligned with the first portion and the second portion.

15. The dispensing system of claim 13, wherein each opening of the plurality of openings is configured to form a seal with the first portion and the second portion, wherein the seal prevents or inhibits the beverage component from leaking out between the dosing collar and the first and second portions.

16. The dispensing system of claim 13, wherein the dosing collar is configured to translate to change which opening of the plurality of openings is aligned with the first portion and the second portion.

17. The dispensing system of claim 13, wherein the dosing collar is configured to rotate to change which opening of the plurality of openings is aligned with the first portion and the second portion.

18. A dispensing system for dispensing a beverage component, the dispensing system comprising:
a container configured to hold the beverage component;
a pump coupled to the container, the pump comprising a tube and a pump head;
a dosing collar comprising restrictors configured to move between a first position and a second position,
wherein the restrictors do not contact the tube when the restrictors are in the first position, and wherein the restrictors are configured to restrict flow the beverage component through the tube when at least one of the restrictors are in the second position in order to modify a volume of the beverage component dispensed from the pump head when the pump head is actuated.

19. The dispensing system of claim 18, wherein the restrictors each comprise a body and a recess extending into the body.

20. The dispensing system of claim 19, wherein the recess of each restrictor is a different size.

21. The dispensing system of claim 19, wherein the recess of each restrictor is a same size.

22. The dispensing system of claim 19, wherein the recess is smaller than the tube so the body necks down a portion of the tube when each restrictor is in the second position.

23. A dosing collar for a beverage component dispensing system, the dosing collar comprising:
a body; and
a plurality of openings extending through the body,
wherein the dosing collar is configured to restrict flow of a beverage component through a tube of the dispensing system,
wherein each opening of the plurality of openings is a different size, so each opening restricts flow of the beverage component through the tube of the dispensing system a different amount.

24. The dosing collar of claim 23, wherein the dosing collar is configured to be positioned between a first portion of the tube and a second portion of the tube so a first opening of the plurality of openings is aligned with the first portion and the second portion.

25. The dosing collar of claim 24, wherein the dosing collar is configured to translate relative to the tube so a second opening of the plurality of openings is aligned with the first portion and the second portion.

26. The dosing collar of claim 24, wherein the dosing collar is configured to rotate relative to the tube so a second opening of the plurality of openings is aligned with the first portion and the second portion.

27. The dosing collar of claim 23, wherein the dosing collar forms a watertight seal with the tube.
